(19) United States
(12) Patent Application Publication
(10) Pub. No.: US 2019/0018134 A1
(43) Pub. Date: Jan. 17, 2019

(54) METHOD AND SYSTEM FOR INSPECTION OF WATERTIGHTNESS OF A VEHICLE

(71) Applicants: HYUNDAI MOTOR COMPANY, Seoul (KR); KIA MOTORS CORPORATION, Seoul (KR)

(72) Inventors: Jun Yeon PARK, Uiwang-si (KR); Haeseong LEE, Anyang-si (KR); Jin Seok KIM, Yongin-si (KR)

(73) Assignees: HYUNDAI MOTOR COMPANY, Seoul (KR); KIA MOTORS CORPORATION, Seoul (KR)

(21) Appl. No.: 16/018,588

(22) Filed: Jun. 26, 2018

(30) Foreign Application Priority Data
Jul. 11, 2017 (KR) 10-2017-0087970

(51) Int. Cl. G01S 15/04; G01M 3/02; G01M 17/007

(52) U.S. Cl. CPC G01S 15/04; G01M 17/007; G01M 3/02

(57) ABSTRACT

A system for inspection of watertightness of a vehicle is disclosed. The system includes: a moving unit to move the vehicle to a workspace; a detection unit to detect the vehicle entering the workspace; a plurality of jet nozzles to jet water toward the vehicle; a valve unit to control water supplied to the plurality of jet nozzles; and a controller to control water jetted toward the vehicle by the plurality of jet nozzles, by controlling the valve unit based on a detection signal from the detection unit. In particular, while the vehicle is moved to the workspace for inspection of watertightness, water is injected toward the vehicle when the vehicle is detected to enter the workspace, and the water injection is stopped when the vehicle is not further detected in the workspace.

### CROSS-REFERENCE TO RELATED APPLICATION

This application claims priority to and the benefit of Korean Patent Application No. 10-2017-0087970, filed on Jul. 11, 2017, the entire contents of which are incorporated herein by reference.

### FIELD

The present disclosure relates to method and system for inspection of watertightness of a vehicle.

### BACKGROUND

The statements in this section merely provide background information related to the present disclosure and may not constitute prior art.

A vehicle is exposed to various types of liquids, e.g., water during washing, and rain while running in the rain. Therefore, an inspection process is performed to test waterproofness while the vehicle is developed or before selling.

Typically during an inspection of waterproofness of a vehicle, water is jetted toward the vehicle by a predetermined pressure and amount while doors and windows of a vehicle are fully closed, and water leakage into an interior of the vehicle is monitored.

For such an inspection, vehicles on a conveyor move to consecutively enter a workspace, where water is continuously jetted toward vehicles that consecutively enter the workspace.

The vehicles enter the workspace with predetermined space between the vehicles. Since the water is continuously jetted toward the moving vehicles, the water is also jetted to the space between the vehicles. The water jetted toward the space is not necessary for inspection of the waterproofness of vehicles.

The above information disclosed in this Background section is only for enhancement of understanding of the background of the present disclosure and therefore it may contain information that does not form the prior art that is already known to a person of ordinary skill in the art.

### SUMMARY

The present disclosure provides a method and a system for inspection of watertightness of a vehicle that may reduce water consumption used for inspection of waterproofness of a vehicle, thereby reducing cost for a waterproofness inspection of a vehicle, without loss of reliability of the inspection.

A method for inspection of watertightness of a vehicle according to an exemplary form includes: moving by a moving unit the vehicle to a workspace, detecting by a detection unit the vehicle entering the workspace; and jetting water by a jet nozzle toward the vehicle when the vehicle is detected to enter the workspace.

In another form, the method may further include retrieving by a controller vehicle information of the vehicle entering the workspace, wherein jet pressure and jet amount is controlled by the controller based on the vehicle information.

The vehicle information may include jet pressure or jet amount of water with respect to the vehicle.

An exemplary method may further include, after the jetting of the water upon entry of the vehicle, stopping the jetting of water toward the vehicle when the vehicle is not further detected.

In the step of detecting the vehicle, the vehicle may be detected based on a signal from an acoustic wave sensor that transmits an acoustic wave and receives a reflected wave of the transmitted acoustic wave.

In the step of detecting the vehicle, the vehicle may be detected based on a signal from a mechanically triggered electrical switch.

In the step of moving the vehicle, a conveyor may be used to move the vehicle to the workspace.

A system for inspection of watertightness of a vehicle according to an exemplary form includes:

a moving unit for moving the vehicle to a workspace,

a detection unit for detecting the vehicle entering the workspace,

a plurality of jet nozzles for jetting water toward the vehicle,

a valve unit for controlling water supplied to the plurality of jet nozzles, and

a controller for controlling water jetted toward the vehicle by the plurality of jet nozzles, by controlling the valve unit based on a detection signal from the detection unit.

The moving unit may include a conveyor for moving the vehicle to the workspace.

The detection unit may include an acoustic wave sensor that transmits an acoustic wave and receives a reflected wave of the transmitted acoustic wave.

The detection unit may include a switch that is mechanically triggered and outputs an electrical signal.

The exemplary system may further include a water jetting pipe arranged to be perpendicular and circumferential to a moving direction of the vehicle, and a pump for supplying water to the water jetting pipe, wherein the plurality of jet nozzles are arranged on the water jetting pipe.

The valve unit may include a pipe valve for controlling supply of water from the pump to the water jetting pipe, and a plurality of nozzle valves for controlling supply of water from the water jetting pipe to the plurality jet nozzles.

Each jet nozzle of the plurality of jet nozzles may include a plurality of component nozzles arranged on a frontal area of the jet nozzle, a plurality of individual valves for individually controlling water supplied to the plurality of component nozzles, and a plurality of individual actuators for operating the plurality of individual valves under a control of the controller.

The plurality of jet nozzles may include a bottom jet nozzle arranged to jet water to a bottom of the vehicle.

According to the exemplary forms above, loss of water may be inhibited or prevented by jetting water based on detection of vehicle entering a workspace and by reducing water jetted to an empty space.

Entering and exiting of the vehicle may be effectively detected by employing an acoustic wave sensor and a mechanically triggered electrical switch.

The jet amount and jet pressure may be controlled based on vehicle information of the vehicle entering the workspace.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram for illustrating a basic scheme of inspection of watertightness of a vehicle;

FIG. 2 is a schematic front view of a system for inspection of watertightness of a vehicle;

FIG. 3 is a schematic lateral view of a system for inspection of watertightness of a vehicle;

FIG. 4 is a block diagram of a system for inspection of watertightness of a vehicle;

FIG. 5 is a flowchart of a method for inspection of watertightness of a vehicle ;

FIG. 6 illustrates a flow of water in a system for inspection of watertightness of a vehicle;

FIG. 7 is a perspective view showing nozzle valve of a system for inspection of watertightness of a vehicle; and

FIG. 8 illustrates a flow of water through a nozzle valve of a system for inspection of watertightness of a vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The size and the thickness of each component illustrated in the drawings are arbitrarily illustrated in the drawings for better understanding and ease of description, but the present disclosure is not limited to the illustration. In the drawings, the thicknesses of various portions and regions are enlarged for clarity.

The drawings and description are to be regarded as illustrative in nature and not restrictive, and like reference numerals designate like elements throughout the specification.

In the following description, dividing names of components into first, second and the like is to divide the names because the names of the components are the same as each other and an order thereof is not particularly limited.

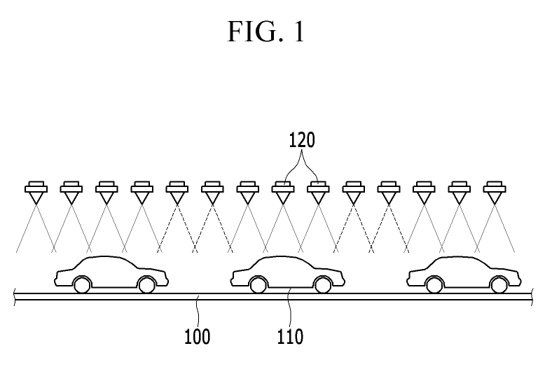

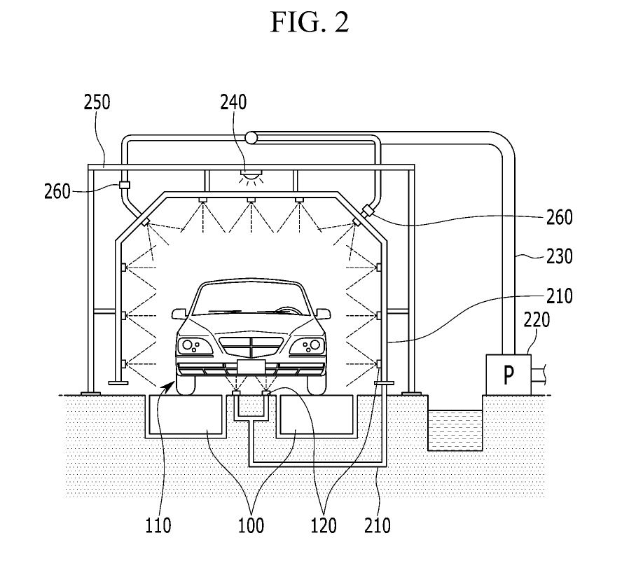

FIG. 1 is a schematic diagram for illustrating a basic scheme of inspection of watertightness of a vehicle according to an exemplary form. FIG. 2 is a schematic front view of a system for inspection of watertightness of a vehicle according to an exemplary form.

Referring to FIG. 1, vehicles 110 are disposed on a conveyor 100, and the vehicles 110 move by the conveyor 100.

Referring to FIG. 2, a system for inspection of watertightness of a vehicle includes a pump 220, a water delivery pipe 230, a lighting 240, a frame 250, a water jetting pipe 210, a pipe valve 260, an array of jet nozzles 120, and the conveyor 100.

Left and right wheels of the vehicle 110 are laid on the conveyor 100 such that the conveyor 100 may move the vehicle 110.

The array of jet nozzles 120 are arranged around the vehicle 110 to jet water toward a roof, sides, and a bottom of the vehicle 110. FIG. 2 illustrates that the three jet nozzles 120 are arranged above the roof of the vehicle 110 to jet water toward the roof, three jet nozzles 120 are arranged at both lateral sides of the vehicle 110 to jet water toward the later sides of the vehicle 110, and one jet nozzle 120 is respectively arranged at each edge between the roof side and the lateral side to jet water toward the edge of the vehicle 110. In addition, two jet nozzles 120 are arranged on a ground of a workspace region so as to jet water toward the bottom of the vehicles. The two jet nozzles 120 arranged on the ground of the workspace region may also be supplied with water from the water jetting pipe 210.

The jet nozzles 120 jetting water toward the roof, lateral sides, and edge of the vehicle are mounted at a water jetting pipe 210, which is formed perpendicular and circumferential to the moving direction of the vehicle 110, such that the jet nozzles 120 mounted at a same water jetting pipe 210 may simultaneously jet water toward the vehicle 110.

Referring back to FIG. 1, the array of jet nozzles 120 are repeatedly arranged along the moving direction of the vehicle 110. Although FIG. 1 illustrates only a single jet nozzle 120 at each location in a moving direction of the vehicle, it should be understood that such is only for the purpose of illustration. The array of jet nozzles 120 illustrated in FIG. 2 is repeatedly arranged along the moving direction of the vehicle 110. That is, the water jetting pipes 210 mounting the jet nozzles 120 are repeatedly arranged along the moving direction of the vehicle 110.

As will be later described in detail, the jet nozzles 120 jet water only toward the vehicle 110, and do not jet water to an open space between the vehicles 110.

The pump 220 pumps and supplies water to the water jetting pipe 210 through the water delivery pipe 230, and the water delivery pipe 230 is provided with a pipe valve 260 for controlling a supply of water to the water jetting pipe 210.

The frame 250 structurally supports the water jetting pipe 210, and the lighting 240 is disposed at an uppermost portion of the frame 250 to light the workspace.

Although a specific number of the jet nozzles 120 are employed in the form, it should be understood that the number and locations of the jet nozzles 120 may be varied based on design factors.

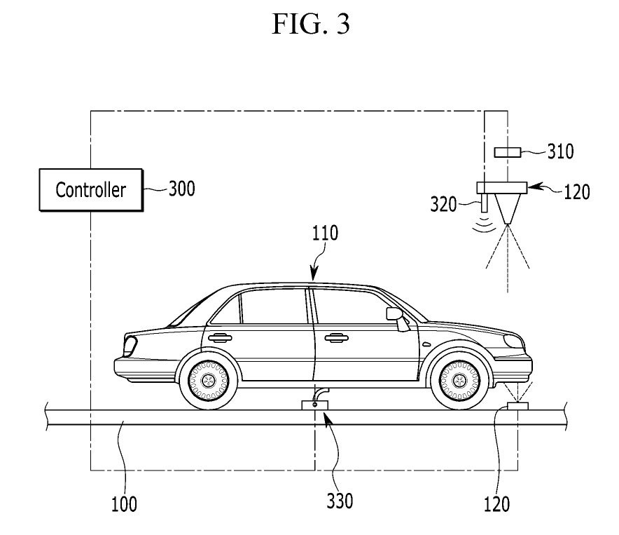

FIG. 3 is a schematic lateral view of a system for inspection of watertightness of a vehicle according to an exemplary form.

Referring to FIG. 3, a system for inspection of watertightness of a vehicle further includes a controller 300, nozzle valves 310, a detection sensor 320, and a detection switch 330.

The detection switch 330 is provided to detect the vehicle 110 entering and exiting the workspace, and may be formed as a mechanically triggered electrical switch. As shown in FIG. 3, the detection switch 330 is disposed on the ground in the conveyor area. When the vehicle 110 enters the workspace, the bottom of the vehicle 110 touches the detection switch 330, and the detection is recognized by the controller 300.

The detection sensor 320 is provided to detect the vehicle 110 entering and exiting the workspace, and may be formed as an electrical sensor sensing a presence of an object. Referring to FIG. 3, the detection sensor 320 is disposed on a same plane with the array of the jet nozzles 120 mounted on a same water jetting pipe 210. FIG. 3 illustrates that the detection sensor 320 is assembled to one jet nozzle 120, however, the present disclosure is not limited thereto. The detection sensor 320 may be formed as an acoustic wave sensor that transmits an acoustic wave, such as an ultrasonic wave, toward the vehicle 110 and receives a reflected wave from the vehicle 110. The detection of the vehicle 110 by the detection sensor 320 is recognized by the controller 300.

In addition, a nozzle valve 310 is employed to control supply of water from the water jetting pipe 210 to the jet nozzle 120. The nozzle valve 310 is operated under the control of the controller 300. Each jet nozzle 120 may be provided with the nozzle valve 310, such that water supply to respective jet nozzle 120 may be controlled separately by the controller 300.

The controller 300 recognizes entering and exiting of the vehicle 110 by signals from the detection sensor 320 and the detection switch 330. The controller 300 controls water supplied to the jet nozzle 120 by controlling the nozzle valve 310.

According to an exemplary form, when the vehicle 110 is determined to have entered to a predetermined location in the workspace, the controller 300 opens the nozzle valve 310 such that the jet nozzle 120 jets water supplied from the nozzle valve 310.

When the vehicle 110 is determined to have exited the workspace, the controller 300 closes the nozzle valve 310 such that the jet nozzle 120 stops jetting water supplied from the nozzle valve 310.

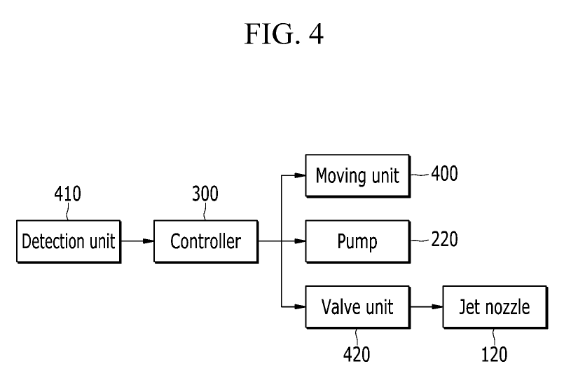

FIG. 4 is a block diagram of a system for inspection of watertightness of a vehicle according to an exemplary form.

Referring to FIG. 4, a system for inspection of watertightness of a vehicle includes a moving unit 400 for moving the vehicle 110, a detection unit 410 for detecting the vehicle 110 entering and exiting the workspace, the above-described jet nozzles 120, a valve unit 420 for controlling water flow to the jet nozzle 120, and a controller 300.

The moving unit 400 moves the vehicle 110 through a system for inspection of watertightness of a vehicle. As described above, the moving unit 400 may be realized as the conveyor 100, and the conveyor 100 may be operated by the controller 300.

The detection unit 410 detects the vehicle 110 entering and exiting the workspace, and may include the above-explained detection sensor 320 and the detection switch 330.

The valve unit 420 includes the above-described pipe valve 260 and the above-described nozzle valve 310.

The controller 300 activates a system for inspection of watertightness of a vehicle, recognizes entering and exiting of the vehicle 110, and controls the valve unit 420 so as to control jetting of water from the jet nozzles 120 toward the vehicle 110. The controller 300 controls jetting of the water from the jet nozzles 120 such that the jet nozzles 120 only jets water toward the vehicle 110 and jetting of water toward an empty space between vehicles 110 may be inhibited or prevented.

The controller 300 may be realized as a microprocessor operated by a predetermined program, and the predetermined program may include a set of instruction to performed a method for inspection of watertightness of a vehicle according to an exemplary form. The controller 300 may include a data storage storing data desired in processing a method for inspection of watertightness of a vehicle according to an exemplary form.

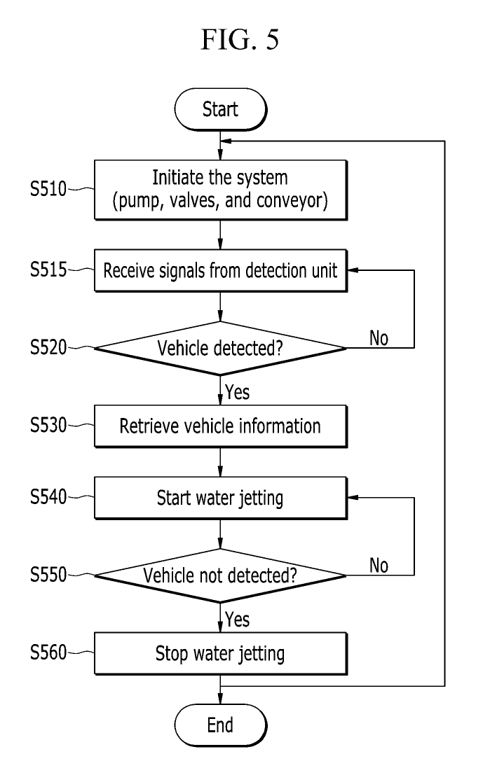

FIG. 5 is a flowchart of a method for inspection of watertightness of a vehicle according to an exemplary form.

Firstly at step S510, the controller initiates the system for inspection of watertightness of a vehicle. The controller 300 activates the pump 220 and opens the pipe valve 260 such that the water forced by the pump 220 is supplied through the water delivery pipe 230 to pipe valve 260. The controller 300 opens the pipe valve 260 and closes the nozzle valve 310. Therefore, the water supplied through the water delivery pipe 230 is supplied to the water jetting pipe 210, and becomes ready to be jetted by the jet nozzle 120.

In addition, the controller 300 activates the conveyor 100 so that the vehicle 110 on the conveyor 100 moves into the workspace.

Subsequently at step S515, the controller 300 starts to receive signals from the detection sensor 320 and the detection switch 330, and thereby detection of the vehicle 110 entering and exiting the workspace is initiated.

Subsequently at step S520, the controller 300 determines whether the vehicle 110 is detected based on the signals from the detection sensor 320 and the detection switch 330. It may be determined that the vehicle 100 has entered the workspace when both the detection sensor 320 and the detection switch 330 send signals for entrance of the vehicle 110. Alternatively, it may be determined that the vehicle 100 has entered the workspace when any of the detection sensor 320 and the detection switch 330 sends a signal for entrance of the vehicle 110.

The controller 300 continues receiving signals from the detection sensor 320 and the detection switch 330 until the vehicle is detected at step S520 (S520; No).

When the vehicle 110 is detected, the controller 300 obtains vehicle information at step S530.

At the step S530, the controller 300 may retrieve the vehicle information from the data storage installed in the controller. Alternatively, the controller 300 may communicate with an external server to obtain the vehicle information. The vehicle information may include a type, a size, and/or a shape of the vehicle entering the workspace. In addition, the vehicle information may include jet pressure and jet amount of the jet valves 120 with respect to the vehicle 110. The controller 300 may retrieve appropriate vehicle information according to various schemes. For a mere example, the controller 300 may retrieve the vehicle information according to a predetermined order of vehicles preinstalled in the data storage.

When the vehicle information is retrieved, the controller 300 controls the valve unit 420 to jet water to the vehicle 110 at step S540. That is, the controller 300 opens the pipe valve 260 and the nozzle valve 310 to jet water to the vehicle 110 at step 420. The jet pressure and jet amount may be determined by the vehicle information, and the controller 300 may perform water jetting by controlling the pipe valve 260 and the nozzle valve 310, e.g., under a pulse width modulation (PWM) scheme.

When the water jetting is started, the controller determines whether the vehicle detection is terminated, i.e., whether the vehicle 110 is not detected, at step S550. The controller continues to jet water at the step S540 (S550; No), until the vehicle 110 is not further detected at the step S550.

At the step S550, the controller 300 determines whether the vehicle 110 is detected based on the signals from the detection sensor 320 and the detection switch 330. It may be determined that the vehicle 100 has entered the workspace when both the detection sensor 320 and the detection switch 330 send signals for entrance of the vehicle 110. Alternatively, it may be determined that the vehicle 100 has entered the workspace when any of the detection sensor 320 and the detection switch 330 sends a signal for entrance of the vehicle 110.

When the vehicle 110 is not further detected at step S550, the controller stops water jetting at step S560, by closing the valve unit 420. At the step S560, the controller 300 may close both the pipe valve 260 and the nozzle valve 310 to stop the water jetting, or close either the pipe valve 260 or the nozzle valve 310. According to the present form, the controller closes the nozzle valve 310 maintaining the pipe valve 260 to be open, so as to jet water more immediately to a subsequently detected vehicle.

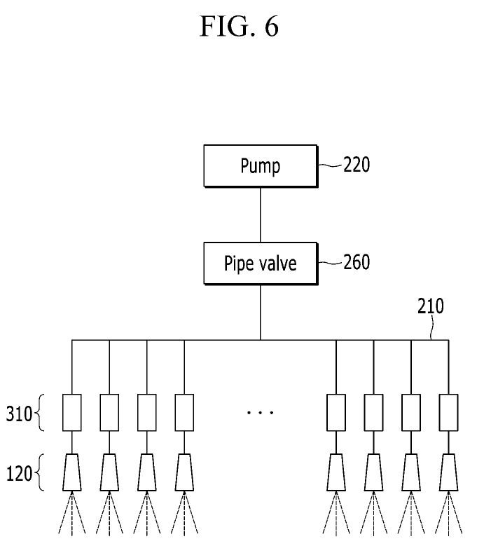

FIG. 6 illustrates flow of water in a system for inspection of watertightness of a vehicle according to an exemplary form.

Referring to FIG. 6, the pump 220 pumps water stored in a reservoir, the pipe valve 260 supplies the water pumped by the pump 220 to the water jetting pipe 210, and the nozzle valve 310 supplies the water from the water jetting pipe 210 to the nozzle valve 310.

The controller 300 controls the pipe valve 260 to control supply of the water to the water jetting pipe 210, and controls the nozzle valve 310 to control water jetting of respective jet nozzles 120.

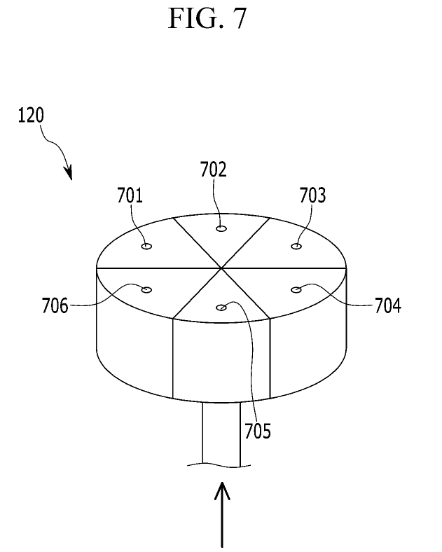

FIG. 7 is a perspective view showing nozzle valve of a system for inspection of watertightness of a vehicle according to an exemplary form.

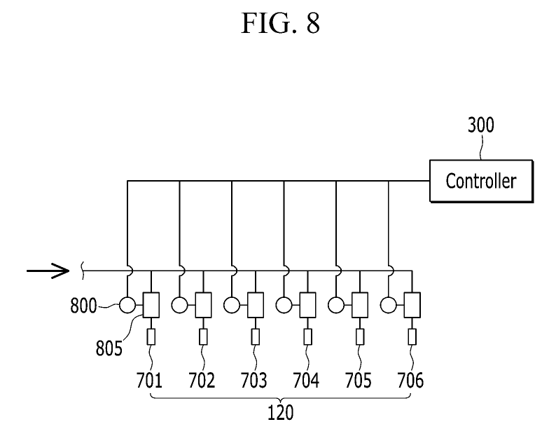

Referring to FIG. 7, the jet nozzle 120 includes a first component nozzle 701, a second component nozzle 702, a third component nozzle 703, a fourth component nozzle 704, a fifth component nozzle 705, and a sixth component nozzle 706 formed on a frontal surface of the jet nozzle 120. The controller 300 may respectively control water jetting of the first to sixth component nozzles 701 to 706 by controlling the nozzle valve 310, which is described below with reference to FIG. 8.

FIG. 8 illustrates flow of water through a nozzle valve of a system for inspection of watertightness of a vehicle according to an exemplary form.

Referring to FIG. 8, each jet nozzle 120 includes first to sixth component nozzles 701 to 706, and the first to sixth nozzles are respectively connected individual valves 805 and individual actuators 800.

That is, each jet nozzle 120 includes six component nozzles 701 to 706, and the six component nozzles 701 to 706 are connected to individual valves 805 controlled by individual actuators 800 controlled by the controller 300. Thus, by controlling the individual valves 805, the controller 300 may individually and independently control the first to sixth component nozzles 701 to 706, by which the jet pressure and the amount may also be controlled based on the vehicle information.

According to the present form, the nozzle valve 310 may be construed to include the six individual valves 805 and the six individual actuators 800.

While this present disclosure has been described in connection with what is presently considered to be practical exemplary forms, it is to be understood that the present disclosure is not limited to the disclosed forms. On the contrary, it is intended to cover various modifications and equivalent arrangements included within the spirit and scope of the present disclosure.

### DESCRIPTION OF SYMBOLS

100: conveyor
110: vehicle
120: jet nozzle unit
210: water jetting pipe
220: pump
230: water delivery pipe
240: lighting
250: frame
260: pipe valve
300: controller
310: nozzle valve
320: detection sensor
330: detection switch
400: moving unit
410: detection unit
420: valve unit
701, 702, 703, 704, 705, 706: first, second, third, fourth, fifth, and sixth component nozzles

What is claimed is:

1. A method for inspection of watertightness of a vehicle, the method comprising the steps of:
moving, by a moving unit, the vehicle to a workspace;
detecting, by a detection unit, the vehicle entering the workspace; and
jetting water by a jet nozzle toward the vehicle when the vehicle is detected to enter the workspace.

2. The method of claim 1, further comprising the step of,
retrieving, by a controller, vehicle information of the vehicle entering the workspace,
wherein jet pressure and jet amount is controlled by the controller based on the vehicle information.

3. The method of claim 2, wherein the vehicle information includes jet pressure or jet amount water with respect to the vehicle.

4. The method of claim 1, further comprising the step of, after the jetting of the water upon entry of the vehicle, stopping the jetting of water toward the vehicle when the vehicle is not further detected.

5. The method of claim 1, wherein, in the step of detecting the vehicle, the vehicle is detected based on a signal from an acoustic wave sensor that is configured to transmit an acoustic wave and receive a reflected wave of the transmitted acoustic wave.

6. The method of claim 5, wherein, in the step of detecting the vehicle, the vehicle is detected based on a signal from a mechanically triggered electrical switch.

7. The method of claim 1, wherein, in the step of moving the vehicle, a conveyor is used to move the vehicle to the workspace.

8. A system for inspection of watertightness of a vehicle, comprising:
a moving unit configured to move the vehicle to a workspace;
a detection unit configured to detect the vehicle entering the workspace;
a plurality of jet nozzles configured to jet water toward the vehicle;
a valve unit configured to control water supplied to the plurality of jet nozzles; and
a controller configured to control water jetted toward the vehicle by the plurality of jet nozzles, by controlling the valve unit based on a detection signal from the detection unit.

9. The system of claim 8, wherein the moving unit comprises a conveyor configured to move the vehicle to the workspace.

10. The system of claim 8, wherein the detection unit comprises an acoustic wave sensor configured to transmit an acoustic wave and receive a reflected wave of the transmitted acoustic wave.

11. The system of claim 8, wherein the detection unit comprises a switch that is mechanically triggered and configured to output an electrical signal.

12. The system of claim 8, further comprising:
a water jetting pipe arranged to be perpendicular and circumferential to a moving direction of the vehicle; and
a pump configured to supply water to the water jetting pipe,
wherein the plurality of jet nozzles are arranged on the water jetting pipe.

13. The system of claim 12, wherein the valve unit comprises:
a pipe valve configured to control supply of water from the pump to the water jetting pipe; and
a plurality of nozzle valves configured to control supply of water from the water jetting pipe to the plurality jet nozzles.

14. The system of claim 8, wherein each jet nozzle of the plurality of jet nozzles comprises:
a plurality of component nozzles arranged on a frontal area of the jet nozzle;
a plurality of individual valves configured to individually control water supplied to the plurality of component nozzles; and
a plurality of individual actuators configured to operate the plurality of individual valves under a control of the controller.

15. The system of claim 8, wherein the plurality of jet nozzles comprises a bottom jet nozzle arranged to jet water to a bottom of the vehicle.
